(19) United States
(12) Patent Application Publication
(10) Pub. No.: US 2019/0041972 A1
(43) Pub. Date: Feb. 7, 2019

(54) METHOD FOR PROVIDING INDOOR VIRTUAL EXPERIENCE BASED ON A PANORAMA AND A 3D BUILDING FLOOR PLAN, A PORTABLE TERMINAL USING THE SAME, AND AN OPERATION METHOD THEREOF

(71) Applicant: CUPIX, INC., Seongnam-si (KR)

(72) Inventor: Seockhoon BAE, Seoul (KR)

(21) Appl. No.: 15/669,672

(22) Filed: Aug. 4, 2017

(51) Int. Cl. G06F 3/01; G06T 19/00

(52) U.S. Cl. CPC G06F 3/011; G06T 19/006

(57) ABSTRACT

According to an embodiment of the present invention, there is provided a method for providing an indoor virtual experience using a portable terminal, the method comprising the steps of: acquiring one or more photographs photographed indoors; acquiring 3D building floor plan information calculated from the one or more photographs; acquiring a panoramic photograph configured such that the one or more photographs match with the 3D building floor plan information; and providing, according to a user input, an indoor virtual experience interface in which the 3D building floor plan information is guided on the panoramic photograph.

### BACKGROUND OF THE INVENTION

### 1. Field of the Invention

The present invention relates to a method for providing indoor virtual experience, a portable terminal using the same, and an operation method thereof.

### 2. Description of the Related Art

Generally, at the time of design drawing of a building, a CAD program is installed in a personal computer or a notebook computer, a drawing is made using a device such as a mouse or a tablet, thereby producing the result.

However, as the society develops from an industrial society to an information society, virtual reality technologies that are able to substitute functions of sample houses and the like by providing the user with the result of 3D modeling itself as a user experience rather than the drawings are emerging.

For example, Virtual Reality (VR) or Augmented Reality (AR) is created for the purpose of virtual tour of a building interior (house, apartment, office, hospital, church, etc.) or furniture placement virtual experience (or indoor virtual experience), and various methods for the user to simulate and interact with the environment and situation based the VR or AR have been proposed.

In particular, technologies for providing information related to indoor architecture using the virtual reality can be largely divided into two types.

One way is to use a panoramic image to provide an image that can be viewed in 360 degrees. Because it reflects the real image, the sense of being on scene can be high. But the panoramic image is two-dimensional, that is, it is planar and there is no sense of depth, which reduces the sense of being on scene. Particularly, in the case of simulating a furniture arrangement or the like in three dimensions, there is a problem that the reality is further deteriorated.

On the other hand, a method of generating three-dimensional (3D) data of a building or an indoor structure using a manual operation or a 3D scanner and providing a virtual reality based on the generated 3D data can be exemplified. However, this method requires a 3D architectural modeling process based on estimation from scanned information or drawings, which not only has difficulty in manufacturing, but also substantially simplifies reality due to limitations of data processing and limitation of manual operation. Thus, there is a problem that the reality or the feeling of liveliness is deteriorated.

Therefore, there is a limitation in which only the experience which is rather different from reality can be provided by the present technology in simulating the indoor information of the building.

### SUMMARY OF THE INVENTION

The present invention is to solve the above-mentioned problems, and the object of which is to provide a method for providing indoor virtual experience based on a panoramic image and a 3D building floor plan, a portable terminal using the same, and an operation method thereof by matching a panoramic photograph which is actually photographed with a 3D building floor plan information extracted therefrom and providing a 3D synchronized guide interface that enables a user to experience a stereoscopic effect of the panoramic photograph through an indoor virtual experience interface based on the panoramic photograph and the 3D building floor plan information to provide the user with a virtual experience such as 3D furniture arrangement in the room realistically even with a portable terminal alone.

According to an embodiment of the present invention to solve the above-mentioned problems, there is provided a method for providing an indoor virtual experience using a portable terminal, the method comprising: acquiring one or more photographs photographed indoors; acquiring 3D building floor plan information calculated from the one or more photographs; acquiring a panoramic photograph in which the one or more photographs are configured to match with the 3D building floor plan information; and providing, according to a user input, an indoor virtual experience interface in which the 3D building floor plan information is guided on the panoramic photograph.

A portable terminal according to an embodiment of the present invention includes: a display unit; a 3D information processing unit for acquiring 3D building floor plan information; a panorama processing unit for acquiring a panoramic photographic image capable of matching with the 3D building floor plan information; and a controller for providing an indoor virtual experience interface in which the 3D building floor plan information is guided on the panoramic photographic image according to a user input to the display unit, further comprising a communication unit for acquiring a plurality of photographic images photographed indoors and photographing coordinate information for each of the plurality of photographic images to transmit to a server, and wherein the communication unit receives, from the server, a panoramic photographic image generated by the server by matching one or more photographic images of the plurality of photographic images to correspond to a main plane using the 3D building floor plan information calculated according to the photographing coordinate information.

A method for providing indoor virtual experience based on a 3D building floor plan by a server device, according to another embodiment of the present invention includes the steps of: receiving, from a portable terminal, one of more photographs photographed indoors in which the portable terminal is located; calculating 3D building floor plan information including a plurality of planes information from the one of more photographs; acquiring a panoramic photographic image configured such that the one of more photographs match with a plane of the 3D building floor plan information; and providing an indoor virtual experience interface, through the portable terminal in which the 3D building floor plan information is guided on the panoramic photographic image, by transmitting the panoramic photographic image and the 3D building floor plan information to the portable terminal, wherein the step of receiving further comprises: receiving photographing coordinate information for each of the plurality of photographic images photographed indoors, and the step of acquiring comprises: generating the panoramic photographic image by matching one or more photographic images of the plurality of photographic images to correspond to a main plane using the 3D building floor plan information calculated according to the photographing coordinate information.

The method according to the present invention may be implemented as a program for execution on a computer and stored in a computer-readable recording medium.

### BRIEF DESCRIPTION OF THE DRAWINGS

FIG. 1 is a conceptual diagram schematically showing an overall system according to an embodiment of the present invention.

FIG. 2 is a block diagram illustrating a portable terminal according to an embodiment of the present invention in more detail.

FIG. 3 is a block diagram illustrating a server according to an embodiment of the present invention in more detail.

FIG. 4 is a ladder diagram illustrating operations between the portable terminal and the server according to the embodiment of the present invention.

FIG. 5 is a diagram illustrating a panoramic photograph and a guide interface according to an embodiment of the present invention.

FIG. 6 is a flowchart illustrating an operation of a portable terminal according to an embodiment of the present invention.

FIGS. 7 to 10 are diagrams illustrating a panoramic photograph and a guide interface to explain an arrangement of 3D virtual objects thereon according to an embodiment of the present invention.

### DETAILED DESCRIPTION OF THE INVENTION

The following merely illustrates the principles of the invention. Thus, those skilled in the art will be able to devise various devices which, although not explicitly described or shown herein, embody the principles of the invention and are included in the concept and scope of the invention. In addition, all of the conditional terms and embodiments listed herein are, in principle, intended only for the purpose of enabling understanding of the concepts of the present invention, and are not intended to be limited to the specifically listed embodiments and conditions.

It is also to be understood that the detailed description of particular embodiments as well as the principles, aspects and embodiments of the invention are intended to cover structural and functional equivalents thereof. It is also to be understood that such equivalents include all elements contemplated to perform the same function irrespective of the currently known equivalents as well as equivalents to be developed in the future.

Thus, for example, it should be understood that the block diagrams herein illustrate conceptual aspects of exemplary circuits embodying the principles of the invention. Similarly, all flowcharts, state transition diagrams, pseudocode, and the like are representative of various processes that may be substantially represented on a computer-readable medium and executed by a computer or processor, whether or not the computer or processor is explicitly shown.

The functions of the various elements shown in the drawings, including the functional blocks shown as a processor or similar concept, may be provided by use of dedicated hardware as well as hardware capable of executing software in connection with appropriate software. When provided by a processor, the functions may be provided by a single dedicated processor, a single shared processor, or a plurality of individual processors, some of which may be shared.

Also, explicit use of terms such as processor, control, or similar concepts should not be interpreted exclusively as hardware capable of running software, and may include implicitly, without limitation, digital signal processor (DSP) hardware, read only memory (ROM), random access memory (RAM), and non-volatile memory for storing software. Other well-known hardware may also be included.

In the claims of the present specification, components represented as means for performing the functions described in the detailed description include all methods of performing functions comprising all types of software, including, for example, a combination of circuit elements performing the function or firmware/microcode, etc., and are coupled with appropriate circuitry for executing the software to perform the functions. As the functions provided by the various listed means are combined and they are combined with the manner in which the claims require, it is to be understood that the invention as defined by the appended claims is to be construed as encompassing any means capable of providing such functionality, which are equivalent to those understood from the present specification.

The above and other objects, features and advantages of the present invention will become more apparent from the following detailed description of the present invention when taken in conjunction with the accompanying drawings, and therefore, those skilled in the art can easily implement the technical idea of the present invention. In the following description, well-known functions or constructions are not described in detail since they would obscure the invention in unnecessary detail.

Now, a preferred embodiment of the present invention will be described in detail with reference to the accompanying drawings.

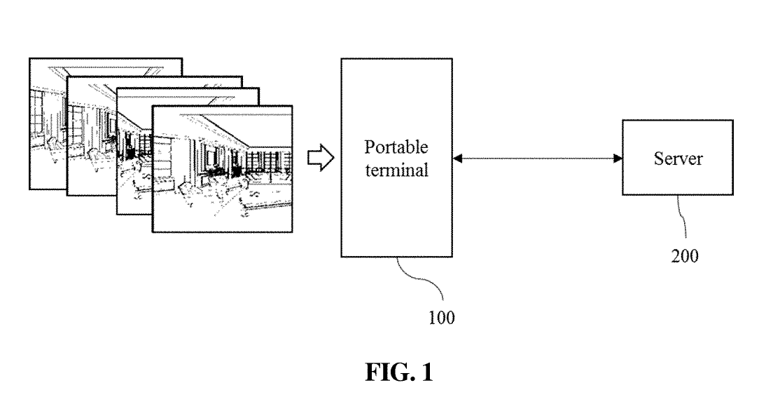

FIG. 1 is a schematic diagram showing an overall system including a portable terminal and a server device according to an embodiment of the present invention.

The overall system for providing indoor virtual experience based on a panoramic photograph and a 3D building floor plans according to an embodiment of the present invention includes a portable terminal 100 and a server device 200.

The portable terminal 100 and the server device 200 can be connected through a network and can communicate with each other.

The network may be any type of wired/wireless network such as a local area network (LAN), a wide area network (WAN), a value added network (VAN), a personal area network (PAN), a mobile radio communication Network, satellite communication network, or the like.

Various electronic devices can be exemplified as the portable terminal 100 described in the present specification such as a mobile phone, a smartphone, a computer, a laptop computer, a digital broadcasting terminal, a personal digital assistant (PDA), a portable multimedia player (PMP), navigation, and the like.

A program or an application for executing the indoor virtual experience providing method according to the embodiment of the present invention may be installed and operated on the portable terminal 100.

Accordingly, the portable terminal 100 according to the embodiment of the present invention can provide an indoor virtual experience, and the indoor virtual experience according to the embodiment of the present invention may be provided through a guide interface in which a panoramic photograph and a 3D building floor plan information corresponding to the panoramic photograph are matched.

To this end, the portable terminal 100 acquires one or more photographs photographed indoors, acquires 3D building floor plan information calculated from the one or more photographs, acquires a panoramic photograph in which the one or more photographs are configured to match with the 3D building floor plan information, and provides, according to a user input, an indoor virtual experience interface in which the 3D building floor plan information is guided on the panoramic photograph, thereby providing an indoor virtual experience based on a panoramic photograph and a 3D building floor plan.

In the present specification, the indoor virtual experience may include a function of visually displaying a reality-like 3D space on a virtual space displayed on a display or the like of the portable terminal 100 and freely arranging the corresponding 3D objects. Accordingly, the indoor virtual experience can be used preferably for a floor planning, which simulates furniture to be placed in a mom, and an application providing an indoor virtual experience may include a floor planning application.

Meanwhile, the server device 200 can store a predetermined application that can be installed in the portable terminal 100 and information necessary for providing the indoor virtual experience. The server device 200 can also provide user registration and 3D object information management features. The portable terminal 100 can download the application from the server device 200 and install it.

In addition, the portable terminal 100 can perform operations for the indoor virtual experience in cooperation with the server device 200. For example, the server device 200 may include a process or a cloud service program for an operation for calculating 3D building floor plan information and an operation process for generating a panoramic photographic image that can be matched with the 3D building floor plan information.

Accordingly, the portable terminal 100 can first transmit one or more photographs photographed indoors to the server device 200.

The server device 200 may receive one or more photographs photographed in the room where the portable terminal 100 is located from the portable terminal 100, calculate 3D building floor plan information including a plurality of planes information from the one or more photographs, acquire a panoramic photograph configured such that the one or more photographs match with a plane of the 3D building floor plan information, transmit the panoramic photograph and the 3D building floor plan information to the portable terminal, and provide an indoor virtual experience interface in which the 3D building floor plan information is guided on the panoramic photograph through the portable terminal.

According to such a system configuration, a panoramic photograph actually photographed in the room can be matched with 3D building floor plan information extracted from the panoramic photograph, and the guide interface three-dimensionally synchronized with the panoramic photograph can be provided. Accordingly, it is possible to provide an indoor virtual experience interface which allows a user to intuitively and realistically experience a stereoscopic effect of the panoramic photograph.

In addition, according to the embodiment of the present invention, when the 3D virtual object is placed on the panoramic image, the 3D virtual object is controlled to be appropriately modified according to the placement area on the guide interface so that the user is provided with a virtual experience such as 3D furniture arrangement in the room based on the guide interface realistically.

Therefore, according to an embodiment of the present invention, not only realistic indoor virtual experience based on panoramic photographs is provided, stereoscopic feeling of panoramic photographs using a guide interface is given, and natural 3D object placement can be provided, which provides the user the same experience as placing objects in an actual space.

The detailed configuration of each device for implementing this will be described in more detail below.

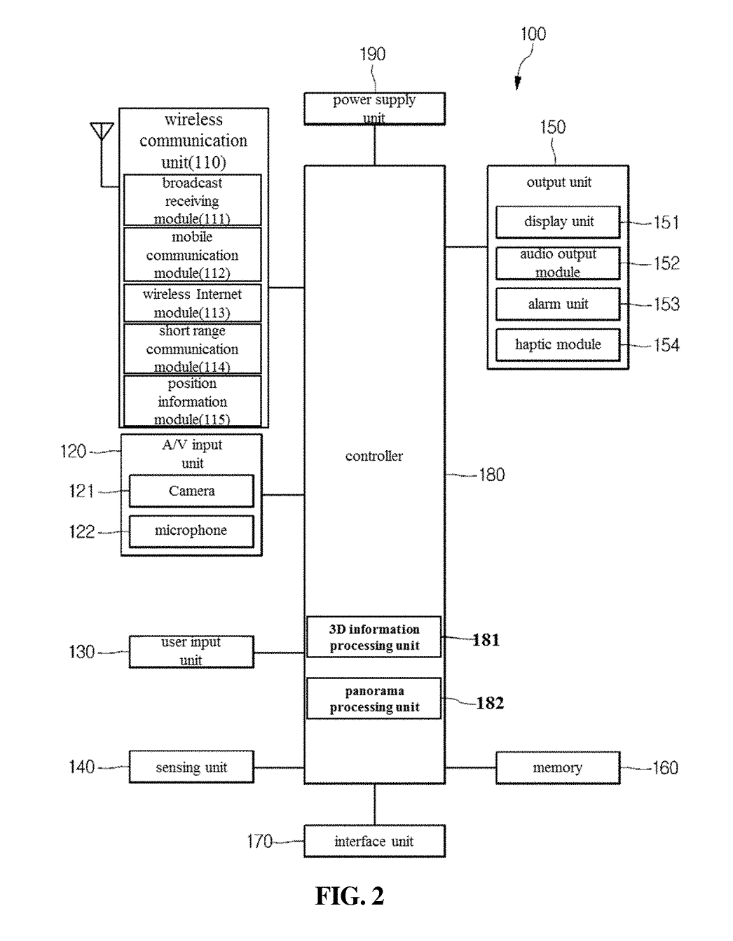

FIG. 2 is a block diagram illustrating a portable terminal according to an embodiment of the present invention in more detail.

Referring to FIG. 2, the portable terminal 100 includes a wireless communication unit 110, an audio/video (A/V) input unit 120, a user input unit 130, a sensing unit 140, an output unit 150, a memory 160, an interface unit 170, a controller 180, a 3D information processing unit 181, a panorama processing unit 182, a power supply unit 190, and the like. The components shown in FIG. 2 are not essential, and a terminal having more or fewer components may be implemented.

The wireless communication unit 110 may include one or more modules for enabling wireless communication between the portable terminal 100 and the wireless communication system or between the portable terminal 100 and the network in which the portable terminal 100 is located. For example, the wireless communication unit 110 may include a broadcast receiving module 111, a mobile communication module 112, a wireless Internet module 113, a short range communication module 114, and a position information module 115, etc.

The mobile communication module 112 transmits and receives a radio signal to at least one of the server device 200, a base station, an external terminal, and a server on a mobile communication network.

The wireless Internet module 113 is a module for wireless Internet access, and it may be built in or mounted on the portable terminal 100. WLAN (Wireless LAN) (Wi-Fi), Wibro (Wireless broadband), Wimax (World Interoperability for Microwave Access), HSDPA (High Speed Downlink Packet Access) and the like can be used as wireless Internet technologies.

The short-range communication module 114 refers to a module for short-range communication. Bluetooth, Radio Frequency Identification (RFID), infrared data association (IrDA), Ultra-Wideband (UWB), ZigBee, and the like can be used as a short range communication technology.

The position information module 115 is a module for obtaining the position of the terminal, and a representative example thereof is a Global Position System (GPS) module.

In addition, for example, the wireless communication unit 110 transmits one or more photographic information photographed indoors to the server device 200, and receives the 3D building floor plan information transmitted from the server device 200 corresponding to the photographic information and the panoramic photograph information that can be matched with the 3D building floor plan information.

Referring FIG. 2 again, the A/V input unit 120 is for inputting an audio signal or a video signal, and may include a camera 121 and a microphone 122. In particular, the camera 121 can be used by a user to directly take a plurality of indoor photographs.

The user input unit 130 generates input data for users operation control of the terminal. The user input unit 130 may include a key pad, a dome switch, a touch pad (pressure/capacitive), a jog wheel, a jog switch, and the like.

The sensing unit 140 senses the current state of the portable terminal 100 such as the open/closed state of the portable terminal 100, the position of the portable terminal 100, the presence of a user contact, the orientation of the terminal, acceleration/deceleration of the terminal, etc. to generate a sensing signal for controlling the operation of the portable terminal 100.

The output unit 150 is for generating output related to visual, auditory or tactile sense and may include a display unit 151, an audio output module 152, an alarm unit 153, and a haptic module 154, etc.

The display unit 151 displays (outputs) information processed in the portable terminal 100. For example, when the terminal is in the indoor virtual experience mode, a UI (User Interface) or a GUI (Graphic User Interface) associated with the indoor virtual experience and the floor planning is displayed. The interface screen may display a panoramic photograph according to an embodiment of the present invention and a corresponding guide interface.

The display unit 151 may be a liquid crystal display (LCD), a thin film transistor-liquid crystal display (TFT LCD), an organic light-emitting diode (OLED), flexible display, or a 3D display.

The audio output module 152 may output audio data received from the wireless communication unit 110 in a call signal reception, a call mode or a recording mode, a voice recognition mode, a broadcast reception mode or stored in the memory 160. The alarm unit 153 outputs a signal for notifying an occurrence of an event of the portable terminal 100.

The memory 160 may store a program for the operation of the controller 180 and temporarily store input/output data (e.g., photograph information, panoramic photograph, 3D building floor plan information, etc.). The memory 160 may store data related to vibration and sound of various patterns outputted upon touch input on the touch screen.

The memory 160 may be a flash memory type, a hard disk type, a multimedia card micro type, a card type memory (e.g., SD or XD memory), a RAM (Random Access Memory), a SRAM (Static Random Access Memory), a ROM (Read Only Memory), an EEPROM (Electrically Erasable Programmable Read-Only Memory), a PROM (Programmable Read-Only Memory), a magnetic disk, and/or an optical disk.

The interface unit 170 serves as a path to all external devices physically connected to the portable terminal 100. The interface unit 170 receives data from an external device or delivers supplied power to each component in the portable terminal 100 or transmits data in the portable terminal 100 to an external device. For example, a wired/wireless headset port, an external charger port, a wired/wireless data port, a memory card port, a port for connecting a device with an identification module, an audio I/O port, a video I/O port, an earphone port, and the like may be included in the interface unit 170.

The controller 180 typically controls the overall operation of the terminal. For example, it performs control and processing for providing indoor virtual experiences, providing interfaces, voice calls, data communications, video calls, and the like.

The controller 180 may include a 3D information processing unit 181 and a panorama processing unit 182 according to an embodiment of the present invention. The 3D information processing unit 181 and the panorama processing unit 182 may be implemented in the controller 180 or separately from the controller 180.

Accordingly, the controller 180 can provide the indoor virtual experience according to the embodiment of the present invention by controlling the 3D information processing unit 181 and the panorama processing unit 182.

First, prior to providing the indoor virtual experience, the portable terminal 100 may acquire the 3D building floor plan information for indoor virtual experience from information of one or more photographs photographed indoors.

For this, the controller 180 acquires the 3D coordinate information of the portable terminal 100 at the time of photographing so that a 3D building floor plan can be generated from the photograph of the actual indoor space in which the user took through the portable terminal 100.

In addition, the controller 180 may provide markers for the user to photograph each vertex of the space (the vertex of the ceiling and the wall, the vertex of the floor and the wall) through the display unit 151 in order to appropriately generate the 3D building floor plan information. Accordingly, the user can acquire the plurality of photographs by photographing a plurality of photographs appropriately for each 3D building plan for each coordinate.

However, in an embodiment of the present invention, the photographing method is not limited to a specific one. The controller 180 may receive and acquire a plurality of indoor photographs successively photographed from an external device as well as the camera 121, or the indoor photograph information stored in the separate memory 160 in advance may be acquired.

On the other hand, the 3D information processing unit 181 acquires the 3D building floor plan information calculated from the one or more photographs.

The 3D information processing unit 181 transmits the plurality of indoor photographs information to the server device 200 and may receive the 3D building floor plan information calculated according to the operation from the server device 200 through the wireless communication unit 110.

Here, various methods can be used to acquire the 3D building floor plan information from the plurality of photographs information. Preferably, a method of measuring 3D coordinates using a photogrammetry technique that extracts 3D coordinate values of a specific point based on several photographs photographed at the same position from different angles can be exemplified.

For example, when the plurality of photographs information includes an object to be measured, 3D coordinate values (x, y, z) of the object can be acquired. And, in the embodiment of the present invention, the object for the indoor virtual experience may include one or more major plane information constituting the interior. The main planes can correspond to the wall surfaces constituting the interior, and they can configure base coordinates for the indoor virtual experience.

Accordingly, the 3D building floor plan information may include one or more main plane information and corresponding base coordinate information.

Then, the panorama processing unit 182 acquires a panoramic photograph in which the one or more photographs are configured to match with the 3D building floor plan information.

The panorama processing unit 182 can receive the panoramic photographs image from the server device 200 configured to match with the 3D building floor plan information extracted from the plurality of photographs to acquire the panoramic photograph.

Accordingly, the controller 180 may generate the indoor virtual experience interface. For example, the received panoramic photograph may constitute a background image for indoor virtual experience, and the controller 180 may provide an indoor virtual experience interface in which the 3D building floor plan information is guided on the panoramic image according to the user input through the user input unit 130.

More specifically, the controller 180 may provide the indoor virtual experience interface through the display unit 151, and may provide an operational function for the virtual experience interface according to a touch or a gesture input corresponding to the display unit 151.

In addition, the controller 180 may display the panoramic photographic image to be rotatable in an omnidirectional manner according to the user input.

Also, the controller 180 may dynamically display a guide image according to the 3D building floor plan information synchronized with a direction and a rotation angle of the panoramic photographic image while the panoramic photographic image is rotated. For example, the controller 180 may synchronize and display the guide image while the touch input to the panoramic photographic image is maintained.

In an embodiment of the present invention, the guide image may include an image of 3D lattice or grid structure providing stereoscopic effect according to the 3D building floor plan information. For example, the guide image may include a lattice or grid structure image overlaid on the main plane of the panoramic photographic image.

Accordingly, the user can experience the stereoscopic feeling added to the panoramic photograph image while rotating the panoramic photograph, and may recognize the space on the photograph realistically and stereoscopically.

In addition, in the embodiment of the present invention, the indoor virtual experience interface may include a first layer including the panoramic image and a second layer including the guide image, and it may be operated in a manner the second layer is overlaid on the first layer according to the user input. For example, transparency, hue, saturation, etc. of the first layer and the second layer may be varied depending on user settings, respectively.

Meanwhile, the controller 180 may, in providing the indoor virtual experience interface, acquire 3D virtual object information which is prepared in advance, control the display unit 151 to arrange the 3D virtual object on the panoramic image according to the user input, determine the placement area of the 3D virtual object based on the coordinate information on the panoramic image according to the arrangement and the 3D building floor plan information, and vary the shape of the 3D virtual object according to the placement area. Here, the 3D virtual object may be at least one of a 3D text, a 3D figure, and a preset object model.

Accordingly, the user can freely and realistically place a 3D virtual object such as furniture on the panoramic image. The size, angle, and the like of the 3D virtual object are varied according to the base coordinates according to the 3D building floor plan information of the guide image, so that the controller 180 enables realistic arrangement matching with the panoramic image.

The controller 180 may also provide an adjustment interface for receiving resizing information of the 3D virtual object through the user input unit 130, and the controller 180 may vary the shape of the 3D virtual object according to the resizing information and the placement area. For example, the controller 180 may display the resizing information of the 3D virtual object on the panoramic image and provide the user with a more accurate calibration of the object shape based on the adjustment information.

Meanwhile, the controller 180 may generate the indoor virtual experience information integrating identification information of the interior, the 3D building floor plan information, the panoramic photographic image, and the placement information of the 3D virtual object, and the generated indoor virtual experience information may be transmitted to the server device 200 through the wireless communication unit 110.

Accordingly, the indoor virtual experience information may be stored and managed in the cloud server or the server device 200 by matching with the user account information of the portable terminal 100.

Meanwhile, the power supply unit 190 receives external power and internal power under the control of the controller 180, and supplies power necessary for operation of the respective components.

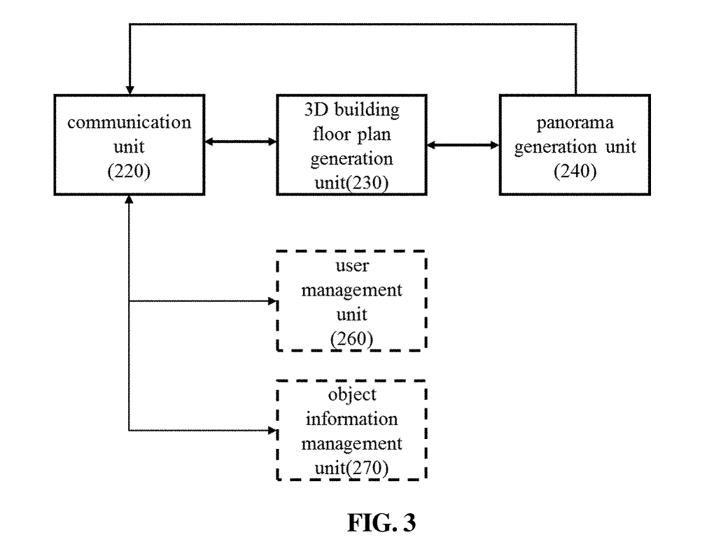

FIG. 3 is a block diagram showing a server according to an embodiment of the present invention in more detail.

Referring to FIG. 3, a server device 200 according to an embodiment of the present invention includes a communication unit 220, a 3D building floor plan generation unit 230, a panorama generation unit 240, a user management unit 260, and an object information management unit 270.

The communication unit 220 can be connected to the portable terminal 100 via a network and can perform communication. The communication unit of the server device 200 transmits at least one of the application installation data, panoramic photograph image, 3D building floor plan information, matching information, and 3D object information to the portable terminal 100, or it may receive a plurality of photographed interior photographic images, a request for 3D object information or the like from the portable terminal 100.

The 3D building floor plan generation unit 230 constructs 3D building floor plan information from the plurality of photographic images received from the portable terminal 100.

As described above, various methods can be used to acquire the 3D building floor plan information from the plurality of photographs information. Preferably, a method of measuring 3D coordinates using a photogrammetry technique that extracts 3D coordinate values of a specific point based on several photographs photographed at the same position from different angles can be exemplified. It is also possible that a separate user constructs the 3D building floor plan information estimated from the plurality of photographs by using 3D building floor plan generation software.

In addition, as described above, when the plurality of photographs information include an object to be measured, 3D coordinate values (x, y, z) of the object can be acquired. And, in the embodiment of the present invention, the object for the indoor virtual experience may include one or more major plane information constituting the interior. The main planes can correspond to the wall surfaces constituting the interior, and they can configure base coordinates for the indoor virtual experience. Accordingly, the 3D building floor plan information may include one or more main plane information and corresponding base coordinate information.

The acquired 3D building floor plan information can be transmitted to the portable terminal 100 through the communication unit 220.

On the other hand, the panorama generation unit 240 generates a panoramic photographic image that can be matched with the 3D building floor plan information from the plurality of photographs information processed from the 3D building floor plan generation unit 230.

Here, the matching process in the embodiment of the present invention may refer to a process for integrating the panoramic image on the 3D building floor plan coordinate plane, rather than a matching of general photographs. That is, the panorama generation unit 240 may perform the matching process according to the embodiment of the present invention so that the 3D building floor plan information and the panoramic photographic image are integrated and naturally overlapped.

Therefore, various methods can be exemplified as the matching method. First, when the plurality of photographs are photographs taken by the 3D scanner device or raw photographs constituting the panoramic image, the 3D building floor plan information is extracted from the photographs, so that the already matched panoramic image can be easily generated without additional matching process.

When the 3D scanning and the photographing are simultaneously performed using a device having both the 3D scanner and the camera lens for photographing, the panorama generation unit 240 receives relative position data between the 3D scanner and the camera lens from the portable terminal 100 separately so that it can perform matching of the 3D building floor plan information based thereon.

Meanwhile, in the case where the 3D building floor plan information is generated in advance by the building software or the like separately from the plurality of photographs information, the panorama generation unit 240 may perform matching by designating feature points on the 3D building floor plan which are matched with feature points on the panoramic image acquired from the plurality of photographs automatically or manually.

Then, the panorama generation unit 240 may transmit the matched panoramic photographic image to the portable terminal 100 through the communication unit 220.

Meanwhile, the user management unit 260 may store and manage the indoor information, the 3D building floor plan information, the panorama information, and the placement information of the 3D virtual object corresponding to the user account information of the portable terminal 100. The storage and management can be shared and managed through a cloud server.

The object information management unit 270 may include a database for collecting and storing 3D object information such as furniture required by the portable terminal 100 in the embodiment of the present invention. The object information management unit 270 may provide the index function of the 3D object information to the portable terminal 100 upon a request of the portable terminal 100.

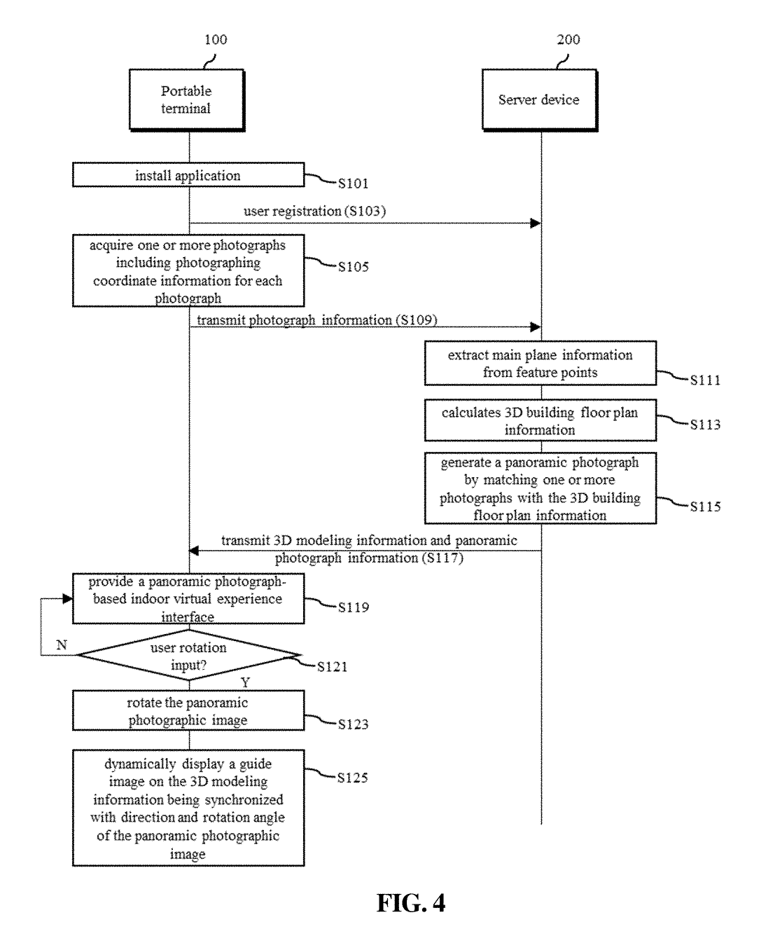

FIG. 4 is a ladder diagram illustrating operations between the portable terminal and the server according to the embodiment of the present invention.

Referring to FIG. 4, the portable terminal 100 first installs an application received through the wireless communication unit 110 (S101), and performs user registration with the server device 200 through the controller 180 (S103).

The portable terminal 100 acquires one or more photographic images including photographing coordinate information for each photographic image from the inside or the outside through at least one of the camera 121, the wireless communication unit 110, and the interface unit 170 (S105).

Then, the portable terminal 100 transmits the photograph information including the one or more photograph images to the server device 200 (S109).

Then, the server device 200 extracts main plane information from the feature points according to the photographing coordinates through the 3D building floor plan generation unit 230 (S111), and calculates the 3D building floor plan information corresponding to the main plane information (S113).

Then, the server device 200 generates the panoramic photographic image by matching the one or more photographic images with the 3D building floor plan information through the panorama generation unit 240 (S115).

Then, the server device 200 transmits the panoramic photograph information including the 3D building floor plan information and the matching information with the panoramic photographic image to the portable terminal 100 through the communication unit 220 (S117).

Thereafter, the portable terminal 100 provides the panoramic photograph-based indoor virtual experience interface through the controller 180 (S119).

Then, the portable terminal 100 determines, through the controller 180, whether a user rotation input is received (S121), and rotates the panoramic photographic image according to the user rotation input (S123).

Accordingly, the portable terminal 100 controls the guide image to be dynamically displayed on the 3D building floor plan information being synchronized with the direction and the rotation angle of the panoramic image through the controller 180 (S125).

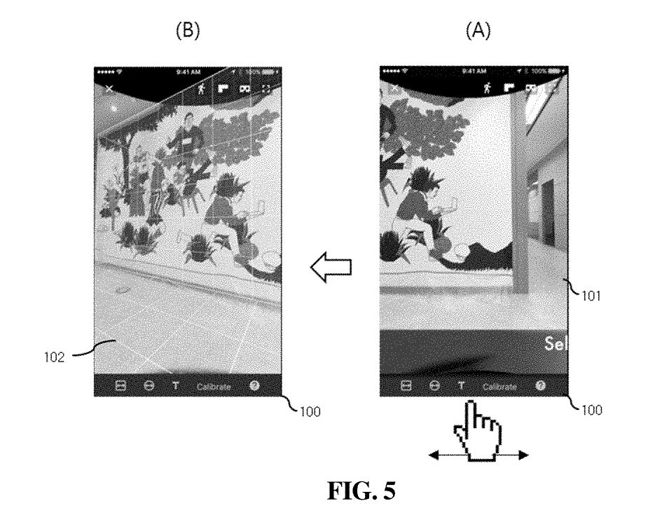

The interface control operation according to the above process will be described with reference to FIG. 5.

FIG. 5 is a diagram illustrating a panoramic photograph and a guide interface according to an embodiment of the present invention.

Referring to FIG. 5 (A), the panoramic photographic image 101 may be displayed on the first layer in the indoor interface of the portable terminal 100 according to the embodiment of the present invention. Here, the user can perform a touch or gesture input for moving or rotating the panoramic photographic image 101 in omnidirectional manner including the leftward, rightward, upward, and downward directions.

Accordingly, referring to FIG. 5 (B), the portable terminal 100 may display the guide image 102 representing the 3D building floor plan information by the lattice or grid structure on the second layer over the first layer while the image rotation according to the user input is processed. Accordingly, when the user rotates or moves the panoramic photograph, the user can feel more stereoscopic and realistic senses of space.

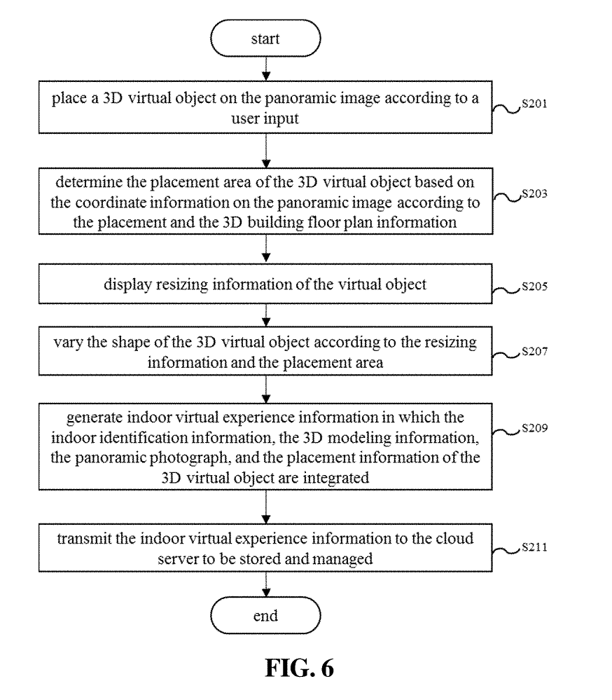

FIG. 6 is a flowchart illustrating an operation of a portable terminal according to an embodiment of the present invention.

Referring to FIG. 6, the portable terminal 100 places, through the control unit 180, the 3D virtual object on the panoramic image according to the user's input (S201).

Then, the portable terminal 100 determines the placement area of the 3D virtual object based on the coordinate information on the panoramic image according to the placement and the 3D building floor plan information through the controller 180 (S203).

Then, the portable terminal 100 displays the resizing information of the virtual object through the display unit 151 (S205), and the portable terminal 100 varies the shape of the 3D virtual object according to the placement area and the resizing information inputted through the user input unit 130 (S207).

When the placement and adjustment are completed, the portable terminal 100 generates the indoor virtual experience information in which the indoor identification information, the 3D building floor plan information, the panoramic photograph, and the placement information of the 3D virtual object are integrated through the controller 180 (S209), and transmits the indoor virtual experience information to the cloud server device 200 through the communication unit 220 to be stored and managed (S211).

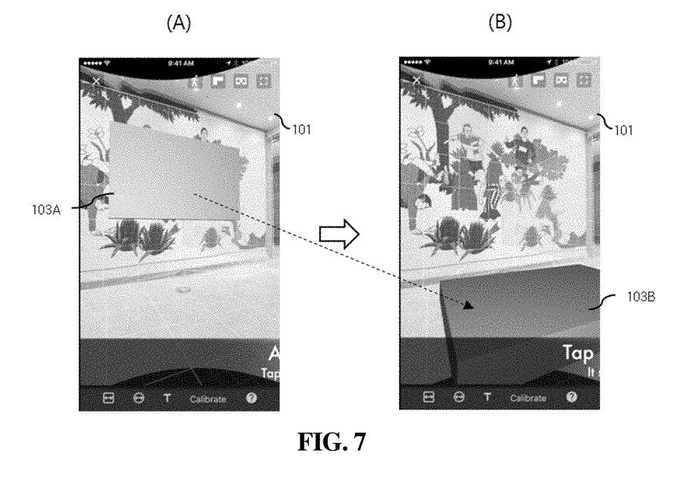

The interface control operation according to the above process will be described with reference to FIG. 7 through FIG. 10.

FIGS. 7 to 10 are diagrams illustrating a panoramic photograph and a guide interface to explain an arrangement of 3D virtual objects thereon according to an embodiment of the present invention.

Referring to FIG. 7 (A), a rectangular parallelepiped FIG. 103A, which is a 3D virtual object, can be placed on the panoramic photographic image 101. In particular, according to the embodiment of the present invention, the shape of the rectangular parallelepiped FIG. 103A can be varied according to the placement area based on the 3D building floor plan information. In FIG. 7 (A), the rectangular parallelepiped FIG. 103A can be formed so as to be arranged on the sidewall surface having the guide image as the base coordinate.

Then, the user can move the rectangular parallelepiped FIG. 103A to the lower end as shown in FIG. 7 (B). Accordingly, since the rectangular parallelepiped FIG. 103A is disposed in a ground area different from the placement area on the side wall surface, its shape and form can be varied.

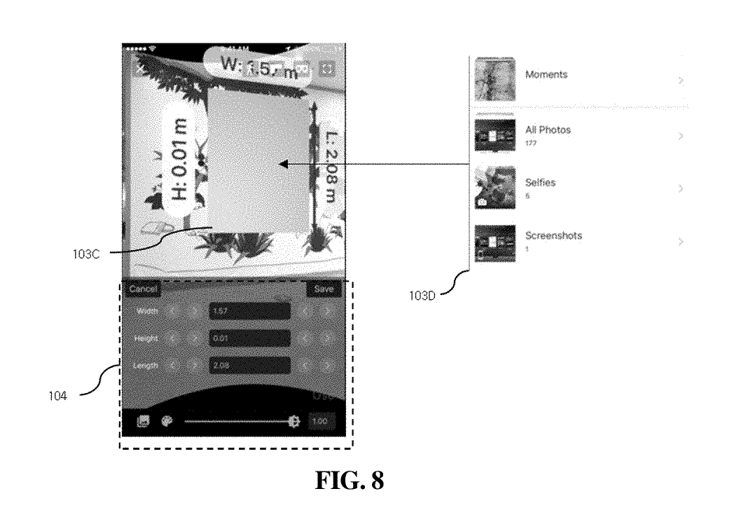

FIG. 8 shows an adjustment interface 104 for more specifically adjusting the shape of the 3D virtual object 103C according to the embodiment of the present invention. The control over the adjustment interface 104 allows the user to precisely adjust the actual size of the 3D virtual object 103C and accurately predict how it will be placed on the panoramic photographic image. Also, as shown in FIG. 8, adjustment values according to the adjustment interface 104 may be displayed around the 3D virtual object 103C.

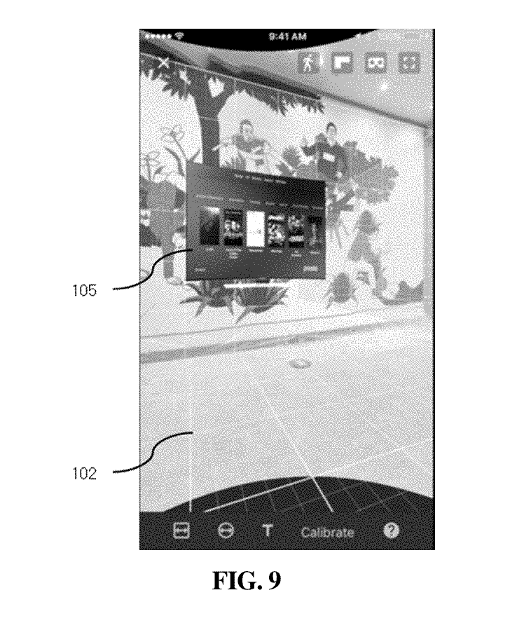

In addition, one or more textures 103D may be selectively applied to the 3D virtual object 103C. As shown in FIG. 9, a TV virtual object 105 having a TV screen texture applied to the 3D virtual object 103C in FIG. 8 may be placed on the guide image 102.

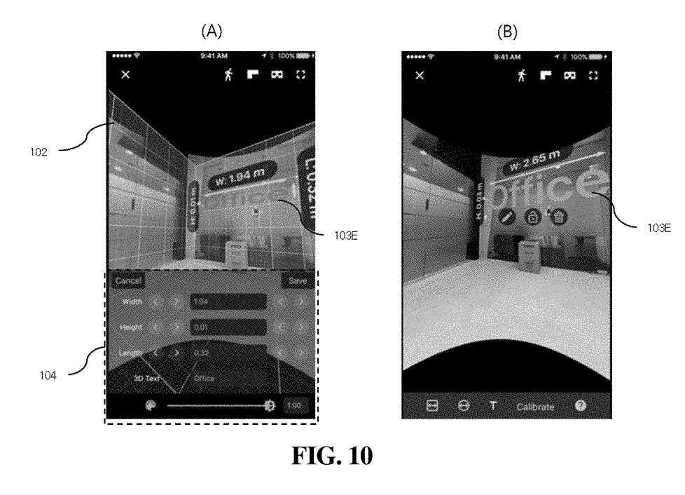

Meanwhile, FIG. 10 illustrates the case where a 3D virtual object is a text object 103E according to an embodiment of the present invention. In the case of text, a text object inputted to the adjustment interface 104 according to the user input may be placed on the panoramic photographic image and the guide image, and the shape and the form may be changed according to the 3D building floor plan information and the placement area thereof.

According to the embodiment of the present invention, the actual photographed panoramic picture and the 3D building floor plan information extracted therefrom can be matched with each other, and the guide interface synchronized with the panoramic picture can be provided. Accordingly, the user can intuitively and realistically experience the stereoscopic effect of the panoramic picture, thereby providing the indoor virtual experience interface.

According to an embodiment of the present invention, when the 3D virtual object is placed on the panoramic image, the user can control the 3D virtual object so that the 3D virtual object is appropriately deformed according to the placement area on the guide interface, 3-Dimensional furniture layout, and so on.

Therefore, according to the embodiment of the present invention, not only realistic room simulation based on panoramic photographs is provided, stereoscopic effect of a panoramic photograph using a guide interface is given, and a natural three-dimensional object arrangement based on the guide interface, it is possible to provide an experience such as placing an object on an actual room.

The above-described method according to the present invention may be implemented as a program for execution on a computer and stored in a computer-readable recording medium. Examples of the computer-readable recording medium include ROMs, RAMs, CD-ROMs, magnetic tapes, floppy disks, optical data storage devices, and the like.

A computer-readable recording medium may store and execute computer readable codes. And, functional programs, codes and code segments for implementing the above method can be easily inferred by programmers of the technical field to which the present invention belongs.

While the present invention has been particularly shown and described with reference to preferred embodiments thereof, it is to be understood that the invention is not limited to the disclosed exemplary embodiments, but, on the contrary, it will be understood that various changes and modifications may be made by those skilled in the art without departing from the spirit and scope of the present invention. These changes and modifications should not be understood individually from the technical idea or viewpoint of the present invention.

1. A method for providing indoor virtual experience of an indoor location based on a panorama and a 3D building floor plan using a portable terminal, the method comprising:
acquiring 3D building floor plan information;
acquiring a panoramic photographic image of the indoor location capable of matching with the 3D building floor plan information; and
providing, according to a user input, an indoor virtual experience interface in which the 3D building floor plan information is guided on the panoramic photographic image,
wherein the step of acquiring a panoramic photographic image comprises:
acquiring a plurality of photographic images photographed in the indoor location and photographing coordinate information for each of the plurality of photographic images to transmit to a server; and
receiving, from the server, the panoramic photographic image generated by the server,
wherein the server generates the panoramic photographic image by matching one or more photographic images of the plurality of photographic images to main plane information corresponding to plane surfaces constituting an interior of the photographed indoor location using the 3D building floor plan information and by integrating the plurality of photographic images on the matched plane surfaces of the 3D building floor plan information of the indoor location so that the 3D building floor plan information and the panoramic photographic image are integrated and naturally overlapped, and
wherein the 3D building floor plan information is calculated according to the photographing coordinate information.

2. The method of claim 1, wherein the step of providing an indoor virtual experience interface comprises:
displaying the panoramic photographic image to be rotatable in omnidirectional manner; and
dynamically displaying a guide image according to the 3D building floor plan information synchronized with a direction and a rotation angle of the panoramic photographic image while the panoramic photographic image is rotated.

3. The method of claim 2, wherein the step of providing an indoor virtual experience interface further comprises:
displaying the guide image synchronously while a touch input to the panoramic photographic image is maintained.

4. The method of claim 2, wherein the guide image includes a lattice or grid structure image overlaid on the matched plane surfaces of the panoramic photographic image.

5. The method of claim 1, wherein the step of providing an indoor virtual experience interface comprises:
acquiring preset 3D virtual object information;
placing, according to the user input, a 3D virtual object according to the preset 3D virtual objection information on the panoramic photographic image;
determining a placement area of the 3D virtual object based on coordinate information on the panoramic photographic image according to the placement area and the 3D building floor plan information; and
varying a shape of the 3D virtual object according to the placement area.

6. The method of claim 5, further comprising:
receiving resizing information of the 3D virtual object; and
varying the shape of the 3D virtual object according to the resizing information and the placement area.

7. The method of claim 6, further comprising:
displaying the resizing information of the 3D virtual object on the panoramic photographic image.

8. The method of claim 5, wherein the 3D virtual object is at least one of a 3D text, a 3D figure, and a preset object model.

9. The method of claim 5, further comprising generating indoor virtual experience information integrating indoor identification information, the 3D building floor plan information, the panoramic photographic image, and the placement area of the 3D virtual object, wherein
the indoor virtual experience information is stored and managed in a cloud server by matching with user account information of the portable terminal.

10. A computer-readable computer program stored on a non-transitory recording medium for causing a computer to execute the method according to claim 1.

11. A portable terminal, comprising:
a display unit;
a 3D information processing unit acquiring 3D building floor plan information of an indoor location;
a panorama information processor acquiring a panoramic photographic image of the indoor location capable of matching with the 3D building floor plan information;
a controller providing an indoor virtual experience interface in which the 3D building floor plan information is guided on the panoramic photographic image according to a user input to the display unit; and
a communication unit acquiring a plurality of photographic images photographed in the indoor location and photographing coordinate information for each of the plurality of photographic images to transmit to a server,
wherein the communication unit receives, from the server, a panoramic photographic image generated by the server,
wherein the server generates the panoramic photographic image by matching one or more photographic images of the plurality of photographic images to main plane information corresponding to plane surfaces constituting an interior of the photographed indoor location using the 3D building floor plan information and by integrating the plurality of photographic images on the matched plane surfaces of the 3D building floor plan information of the indoor location so that the 3D building floor plan information and the panoramic photographic image are integrated and naturally overlapped, and
wherein the 3D building floor plan information is calculated according to the photographing coordinate information.

12. The portable terminal of claim 11, wherein the controller displays the panoramic photographic image through the display unit to be rotatable in omnidirectional manner, and dynamically displays a guide image according to the 3D building floor plan information according to a direction and a rotation angle of the panoramic photographic image while the panoramic photographic image is rotated.

13. The portable terminal of claim 12, wherein the controller controls the display unit to display the guide image while a touch input to the panoramic photographic image is maintained.

14. The portable terminal of claim 12, wherein the guide image includes a lattice structure image overlaid on the matched plane surfaces of the panoramic photographic image.

15. The portable terminal of claim 11, wherein the controller acquires a preset 3D virtual object information, and,
according to the user input, places a 3D virtual object according to the 3D virtual object information on the panoramic photographic image, determines a placement area of the 3D virtual object based on coordinate information on the panoramic photographic image according to the placement area and the 3D building floor plan information, and varies a shape of the 3D virtual object according to the placement area.

16. The portable terminal of claim 15, wherein the controller varies the shape of the 3D virtual object according to resizing information and the placement area if the resizing information of the 3D virtual object is inputted.

17. The portable terminal of claim 16, wherein indoor information, the 3D building floor plan information, the coordinate information on the panoramic photographic image, and the placement area of the 3D virtual object are stored and managed in a cloud server by matching with user account information of the portable terminal.

18. A method for providing indoor virtual experience of an indoor location based on a 3D building floor plan by a server device, the method comprising:
receiving, from a portable terminal, one or more photographs photographed in the indoor location in which the portable terminal is located;
calculating 3D building floor plan information including a plurality of planes information from the one of more photographs;
acquiring a panoramic photographic image of the indoor location configured such that the one or more photographs match with a plane of the 3D building floor plan information; and
providing an indoor virtual experience interface, through the portable terminal, in which the 3D building floor plan information is guided on the panoramic photographic image, by transmitting the panoramic photographic image and the 3D building floor plan information to the portable terminal, wherein the step of receiving further comprises:
receiving photographing coordinate information for each of the plurality of photographic images photographed in the indoor location, and wherein the step of acquiring comprises:
generating the panoramic photographic image by matching one or more photographic images of the plurality of photographic images to main plane information corresponding to plane surfaces constituting an interior of the photographed indoor location using the 3D building floor plan information and by integrating the plurality of photographic images on matched plane surfaces of the 3D building floor plan information of the indoor location so that the 3D building floor plan information and the panoramic photographic image are integrated and naturally overlapped, and wherein the 3D building floor plan information is calculated according to the photographing coordinate information.
